(19) United States
(12) Patent Application Publication
(10) Pub. No.: US 2009/0146629 A1
(43) Pub. Date: Jun. 11, 2009

(54) METHODS AND APPARATUS FOR POWER SUPPLY

(75) Inventor: FELIX KIM, Plano, TX (US)

Correspondence Address: THE NOBLITT GROUP, PLLC, 4800 NORTH SCOTTSDALE ROAD, SUITE 6000, SCOTTSDALE, AZ, 85251, US

(73) Assignee: Primarion, Inc.

(21) Appl. No.: 12/332,660

(22) Filed: Dec. 11, 2008

Related U.S. Application Data
(60) Provisional application No. 61/012,897, filed on Dec. 11, 2007.

(51) Int. Cl. G05F 1/00

(52) U.S. Cl. 323/282

(57) ABSTRACT

Methods and apparatus for supplying a load according to various aspects of the present invention operate in conjunction with an output stage and a control system driving the output stage. The control system may include a PWM controller adapted to provide a drive signal to the output stage and an over-current protection circuit. The over-current protection circuit may sense an over-current condition at the load and truncate the drive signal in response to the over-current condition.

### CROSS-REFERENCES TO RELATED APPLICATIONS

This application claims the benefit of benefit of U.S. Provisional Patent Application No. 61/012,897, filed Dec. 11, 2007, and incorporates the disclosure of such application by reference.

### BACKGROUND OF THE INVENTION

In many pulse width modulation (PWM) controlled power supplies, over-current protection (OCP) may be required to protect the power supply and/or the load, prevent inductor saturation, and to aid current balancing. OCP is typically implemented using sampled and averaged current sensing. Such systems may be too slow to be effective, for example due to finite sampling and averaging latency delay.

### SUMMARY OF THE INVENTION

Methods and apparatus for supplying a load according to various aspects of the present invention operate in conjunction with an output stage and a control system driving the output stage. The control system may include a PWM controller adapted to provide a drive signal to the output stage and an over-current protection circuit. The over-current protection circuit may sense an over-current condition at the load and truncate the drive signal in response to the over-current condition

### BRIEF DESCRIPTION OF THE DRAWING FIGURES

A more complete understanding of the present invention may be derived by referring to the detailed description and claims when considered in connection with the following illustrative figures. In the following figures, like reference numbers refer to similar elements and steps throughout the figures.

FIG. 1 is a block diagram of a power supply according to various aspects of the present invention coupled to a load.

FIG. 2 is a schematic of an exemplary output stage.

FIG. 3 is a block diagram of a system including an exemplary control system.

FIG. 4 is a schematic of an exemplary control system.

FIG. 5 is a schematic of a blanking circuit.

FIG. 6 is a flowchart of a power supply method.

Elements and steps in the figures are illustrated for simplicity and clarity and have not necessarily been rendered according to any particular sequence. For example, steps that may be performed concurrently or in different order are illustrated in the figures to help to improve understanding of embodiments of the present invention.

### DETAILED DESCRIPTION OF EXEMPLARY EMBODIMENTS

The present invention may be described in terms of functional block components and various processing steps. Such functional blocks may be realized by any number of techniques, technologies, and methods configured to perform the specified functions and achieve the various results. For example, the present invention may employ various controllers, sensors, power supplies, logic circuits, output stages, comparing circuits, clocks, latches, and the like, which may carry out a variety of functions. In addition, the present invention may be practiced in conjunction with any number of devices for performing the various functions, and the systems described are merely exemplary applications. Further, the present invention may employ any number of conventional techniques sensing current, comparing signals, truncating signals, and the like.

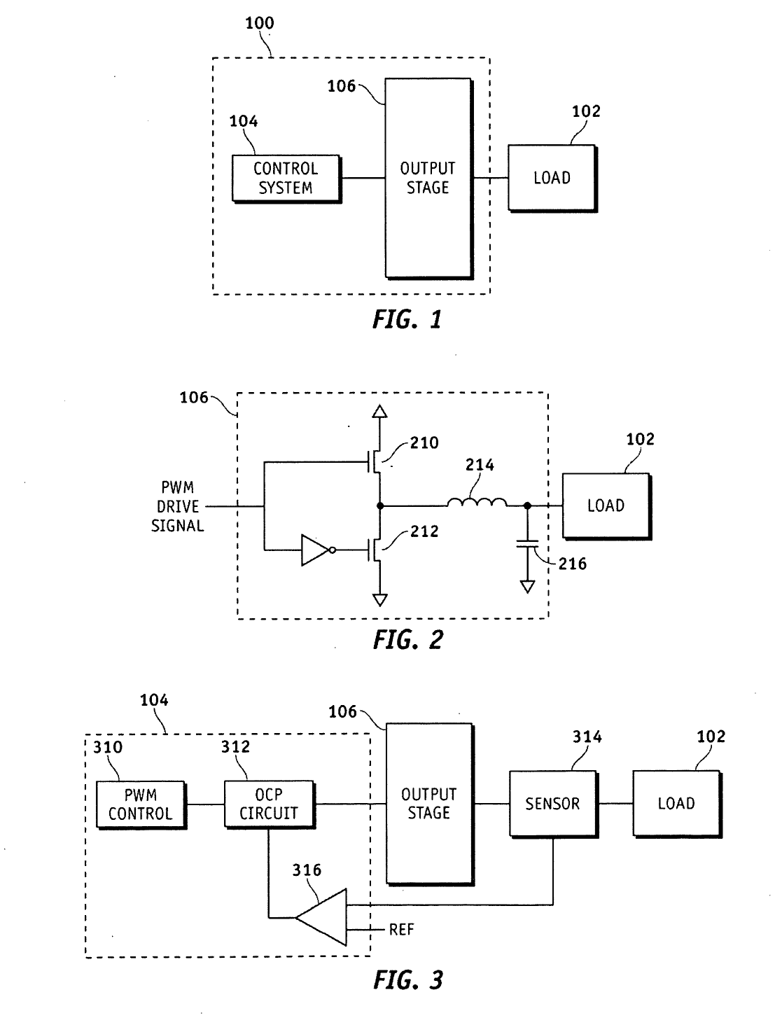

Methods and apparatus for supplying a load according to various aspects of the present invention operate in conjunction with a pulse width modulation (PWM) controller adapted to drive a signal provided to the load. For example, referring to FIG. 1, a power supply 100 for supplying current to a load 102 according to various aspects of the present invention comprises an output stage 106 and a control system 104. The control system 104 drives the output stage 106, and the output stage 106 provides current to the load 102. Various aspects of the present invention may be applied to any appropriate power supply, such as buck, boost, buck-boost, forward, flyback, half-bridge, full-bridge, and SEPIC topologies.

In the present embodiment, the output stage 106 is responsive to the control system 104 and provides current to the load 102 according to a drive signal from the controller. The output stage 106 may comprise any appropriate system for providing current to the load 102 according to a PWM. drive signal. Referring t) FIG. 2, an exemplary output stage 106 may comprise a high-side FET 210 and a low-side FET 212. The PWM drive signal alternately drives the FETs 210, 212 to alternately connect the load 102 to the power supply 100. A filter circuit, such as an inductor 214 and a capacitor 216, smoothes the voltage and current applied to the load 102.

The control system 104 generates the PWM drive signal to drive the output stage 106. The control system 104 may generate the PWM signal according to any appropriate techniques and criteria, such as using conventional voltage and/or current feedback to control the voltage and/or current applied to the load 102. The control system 104 may also include any appropriate elements and systems for generating the PWM drive signal. For example, referring to FIG. 3, the control system 104 may include a PWM controller 310 and an over-current protection (OCP) circuit 312. The PWM controller 310 provides the drive signal to the output stage 106. The OCP circuit 312 may prevent excessive current from being applied to the load 102, such as by sensing an over-current condition at the load 102 and truncating the PWM drive signal in response to the over-current condition. The control system 104 may thus provide reduced latency and delay.

The PWM controller 310 generates the drive signal to control the power delivered to the load 102. The PWM controller 310 may comprise any suitable system for generating the pulse width modulated drive signal to drive the output stage 106. For example, the PWM controller 310 may comprise a conventional PWM controller 310 for a switched mode power supply that delivers a PWM signal to drive the output stage 106 and regulate the output of the power supply 100. The PWM controller 310 may change the duration of the pulses in the drive signal to adjust the tine that the power source is connected to the load 102, thus controlling the voltage and/or current application to the load 102. The PWM controller 310 may modulate the drive signal according to any appropriate criteria, such as output voltage or output current. In addition, the PWM controller 310 may comprise a single-phase or multi-phase system. In the present embodiment, the PWM controller 310 comprises a conventional PWM-based voltage regulator for a power supply that adjusts the drive pulse duration according to output voltage or current compared to a target output voltage or current.

The OCP circuit 312 inhibits excessive current from being applied to the load 102. In particular, the OCP circuit 312 detects an over-current condition and truncates the PWM drive signal to terminate the over-current condition.

The over-current condition may be defined and determined in any appropriate manner. For example, the over-current condition may be defined as a current magnitude exceeding a predetermined threshold magnitude. Thus, if the load 102 should not receive a current of greater than 10 Amperes, then the over-current condition may be defined as any current exceeding 10 Amperes. The over-current condition may be defined according to any appropriate terms, such as current magnitude, voltage magnitude, and/or duration of a peak current or voltage, and may be selected according to any appropriate criteria, such as characteristics of the load 102, the supply, the output stage 106, or connectors.

The OCP circuit 312 may respond to any appropriate indicator of the over-current condition or otherwise detect the over-current condition, such as by directly or indirectly sensing a relevant current. For example, the OCP circuit 312 may receive a signal from a sensor 314 corresponding to the magnitude of a relevant current and control the over-current condition accordingly. For example, a current sensor may be connected to the output of the power supply 100, which generates a signal according to the magnitude of the current provided to the load 102. By receiving the sensor 314 signal, the OCP circuit 312 may sense an over-current condition at the load 102.

The OCP circuit 312 may identify whether an over-current condition has occurred in any appropriate manner, such as by converting an analog current sensor signal to a digital signal and processing the result. Alternatively, the OCP circuit 312 may compare the current sensor signal to a threshold representing the maximum acceptable current. In the present embodiment, the OCP circuit 312 receives a signal from a comparing circuit 316, which compares the current sensor signal to a reference signal and generates an over-current signal according to the comparison.

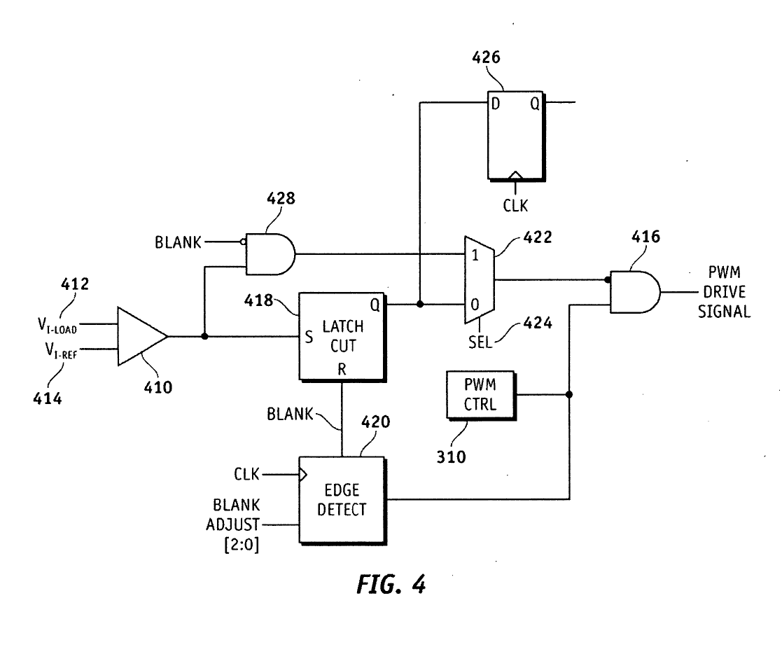

The comparing circuit 316 may comprise any suitable circuit for comparing signals and generating the over-current signal. Referring to FIG. 4, in one embodiment, the comparing circuit 316 may comprise a high-speed comparator 410 adapted to quickly generate a binary signal according to whether the value at one input exceeds the other. Thus, the comparing circuit 316 may generate a first signal level, such as a low voltage, when the current sensor signal voltage 412 is less than the reference voltage 414, and a second signal level, such as a high voltage, when the current sensor signal voltage 412 is greater than the reference voltage 414.

The output of the comparing circuit 316 is provided to the OCP circuit 312, which may truncate the PWM drive signal upon detection of an over-current condition. The OCP circuit 312 may truncate the PWM drive signal in any appropriate manner, such as by providing a signal to the PWM controller 310 upon detection of an over-current condition. The PWM controller 310 may then terminate the PWM drive signal. Alternatively, the OCP circuit 312 may directly terminate the PWM drive signal before the PWM drive signal is applied to the output stage 106 or the load 102.

In one embodiment, the OCP circuit 312 may continuously truncate the PWM drive signal while the over-current condition persists. The OCP circuit 312 may continuously truncate the PWM drive signal according to any suitable technique or system. For example, referring to FIG. 4, the OCP circuit 312 may selectively drive the PWM drive signal to disconnect the power source from the load 102 for the duration of the over-current condition. An exemplary OCP circuit 312 may comprise an AND logic gate 416 comprising an output driving the output stage 106, one input connected to the output of the PWM controller 310, and another inverting input connected to the output of the comparing circuit 316. In this exemplary configuration, the PWM drive signal from the PWM controller 310 is transmitted to the output stage 106 when the comparing circuit 316 output is low, indicating the absence of an over-current condition. Upon development of an over-current condition, the output of the comparing circuit 316 is high, which causes the AND logic gate 416 to generate a low signal, which in turn opens the high-side FET 210 between the power source and the load 102 and closes the low-side FET 212 between ground and the load 102.

Alternatively, the OCP circuit 312 may operate in a latched mode to maintain the PWM drive signal truncation for a selected time, such as for a designated period or until a particular event, following detection of an over-current condition. For example, the OCP circuit 312 may truncate the PWM signal for the remainder of the PWM cycle in which the over-current condition occurs. Thus, the OCP circuit 312 may selectively and independently truncate each individual pulse of the PWM drive signal.

The OCP circuit 312 may be configured in any appropriate manner to latch the PWM drive signal in a selected condition for a selected period, such as the duration of a PWM pulse or until the occurrence of an event. For example, referring again to FIG. 4, the OC P circuit 312 may comprise a latch circuit 418, such as a conventional set-reset (SR) latch or other memory element. In the present embodiment, the latch Circuit 418 comprises a reset dominant SR latch that drives the Q output high when the R input is held low and the S input is driven high. The output remains high until the R input is pulsed, at which time the Q output is driven low and remains low until the S input is again pulsed while the R input is held low.

The S input may be connected to the output of the comparing circuit 316. The R input may be connected to a trigger signal to trigger a reset of the latch. In one embodiment, the latch circuit 418 is reset by an edge detect circuit 420 adapted to pulse the R input of the latch circuit 418 in response to the falling edge of the PWM controller 310 output. In this configuration, the latch circuit 418 truncates the PWM signal provided to the output stage 106 when an over-current condition is detected and signaled at the S input of the latch circuit 418. The output of the latch circuit 418 is driven high, which drives the output of the AND gate 416 low and truncates the signal provided to the output stage 106. The falling edge of the PWM controller 310 signal causes the edge detect circuit 420 to pulse the R input of the latch circuit 418, causing the latch circuit 418 output to be reset to a low state. As a result, the each individual pulse of the PWM drive signal may be individually truncated by the latch circuit 418.

The OCP circuit 312 may further comprise a compensation mechanism to avoid improper operation due to signal fluctuations, glitches, noise, and/or other instability. Inadvertent fluctuations may cause improper responses. For example, noise associated with PWM switching may cause false comparator outputs, which may in turn affect the operation of the OCP circuit 312. The OCP circuit 312 may be configured in any suitable manner to filter or otherwise compensate for such fluctuations and glitches.

For example, the edge detect circuit 420 may comprise a blanking circuit adapted to disable the effects of fluctuations and glitches for a selected period of time. In the present embodiment, the blanking circuit is integrated into the edge detect circuit and blanks the effects of the OCP circuit 312 for a selected period of time, such as for a selected period following the beginning of a PWM pulse from the PWM controller 310. The blanking circuit may be adapted for any appropriate effects, such as to mask out any false comparator decisions due to PWM switching noise. Referring to FIG. 5, in the present embodiment, the blanking circuit 510 may generate a pulse of a selected duration in response to the rising edge of the. PWM controller 310 signal. The pulse is provided to the R input of the latch circuit 418, which inhibits the latch circuit 418 from switching its output to high in response to a signal at the S input. The blanking circuit may also be adapted to control the output of the OCP circuit 312 in continuous mode. For example, the output of the comparing circuit 316 may be provided to one input of an AND logic gate 428, and the inverse of the blanking circuit signal may be connected to a second input of the AND logic gate 428. Consequently, the assertion of the blanking signal drives the output of the AND logic gate 428 low, regardless of the output of the comparing circuit 316, disabling the effects of OCP circuit 312 on the PWM drive signal.

For example, the blanking circuit 510 may comprise an exclusive OR (XOR) logic gate 512 and a delay circuit 514. The delay circuit 514 delays the propagation of a signal for a selected period. The present delay circuit 514 is programmable via an input, such as a multiple bit signal 516 that indicates a desired duration of the blanking pulse, such as multiples of a clock signal provided to the delay circuit 514. The delay circuit 514 receives the PWM controller 310 signal and transmits the signal to one input of the XOR gate 512 after a selected duration. A second input of the XOR gate 512 receives the PWM controller 310 output. In this configuration, the XOR gate 512 output may be low when the PWM controller 310 output is low. When the PWM controller 310 generates a rising edge, the output of the XOR gate is driven high while the PWM controller 310 signal propagates through the delay circuit 514. When the output of the delay circuit 514 goes high, the output of the XOR gate returns to low: Thus, the present blanking circuit 510 generates a pulse in response to the rising edge of the PWM controller 310 signal, and the pulse endures for the selected duration associated with the delay circuit 514.

The OCP circuit 312 may be further adapted to selectively operate in either continuous mode or latched mode. The OCP circuit 312 may be adapted in any suitable manner to facilitate switching between continuous mode and latch mode. In the present embodiment, referring again to FIG. 4, the OCP circuit 312 includes a multiplexer 422, such as a conventional multiplexer, comprising a first input connected to the comparing circuit 316, such as directly or via the AND gate 428 coupled to the blanking circuit 510. The multiplexer 422 may include a second input connected to the output of the latch circuit 418. The OCP circuit 312 may be set to operate in either continuous mode or latched mode by selecting the input connected to the output via a selection input 424.

The OCP circuit 312 may further generate signals corresponding to power supply operation, such as for fault reporting, loop control, and/or other purposes. For example, the OCP circuit 312 may comprise a reporting circuit 426 adapted to transmit and/or generate signals corresponding to the operation of the OCP circuit 312. In the present embodiment, the reporting circuit 426 comprises a conventional D latch receiving the latch circuit 418 output at a D input and a control signal at the enable input. Thus, the signals from the latch circuit 418 may be monitored via the reporting circuit 426 by monitoring the output of the reporting circuit 426 and controlling its operation, such as via the control signal at the enable input and/or selection of signal applied at a clock input.

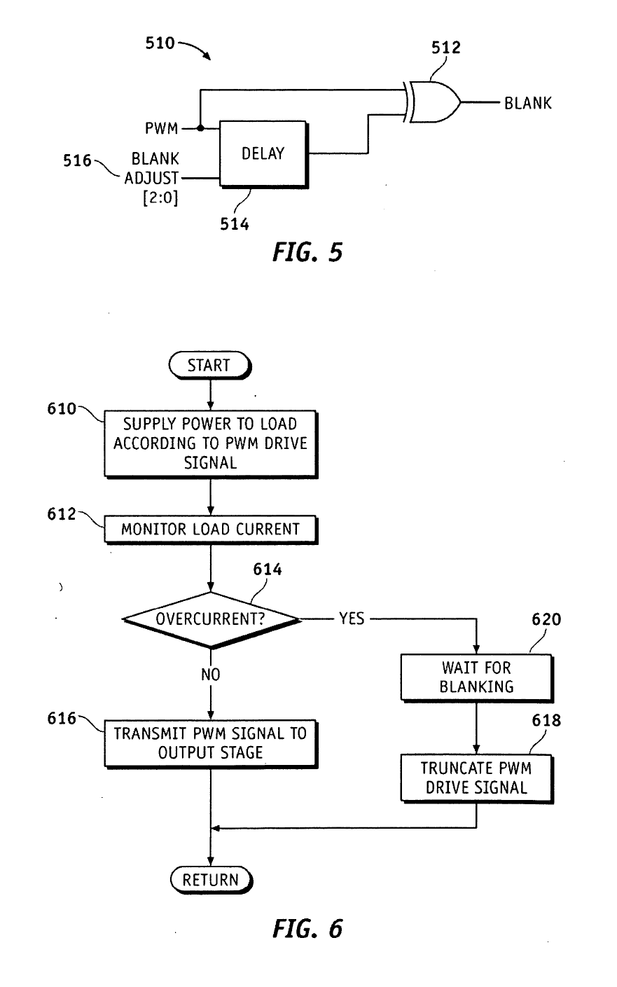

In operation, the power supply 100 supplies a current to the load 102. Generally, referring to FIG. 6, the power supply 100 supplies current to the load 102 according to the PWM drive signal (610). The OCP circuit 312 monitors the current applied to the load 102 (612) and senses whether an over-current condition exists (614). In the event of an over-current condition, the OCP circuit 312 may truncate the PWM signal and reduce the current supplied to the load 102.

More particularly, when an over-current condition is not occurring, the power supply 100 may provide current to the load 102 as a conventional PWM supply (616). For example, the PWM controller 310 may provide the PWM signal to the output stage 106, which alternately connects and disconnects the power source to the load 102. The PWM controller 310 may modulate the PWM drive signal provided to the output stage 106 according to any appropriate criteria or algorithm, such as to maintain a desired voltage at the output of the power supply 100.

The power supply 100 may sense an over-current condition, such as by directly or indirectly sensing the current magnitude and comparing the magnitude to an over-current threshold, such as a static, dynamic, or selectable threshold. In the present embodiment, the current sensor determines the magnitude of the current provided to the load 102 and generates the corresponding load current signal. The load current signal is provided to the comparing circuit 316, which compares the load current signal to the over-current threshold signal corresponding to the over-current threshold. The comparing circuit 316 generates the over-current signal indicating whether an over-current condition exists according to the comparison. In the present embodiment, the comparing circuit 316 generates a high binary signal when the load current signal received at one input exceeds the over-current threshold voltage received at a second input.

When an over-current condition is detected, the power supply 100 truncates the PWM drive signal (618), thus disconnecting the power source from the load 102 via the output stage 106. For example, the power supply 100 may operate in the continuous mode such that the PWM drive signal is truncated only for so long as the over-current condition persists. Thus, when the comparing circuit 316 indicates that an over-current condition exists, the power supply 100 may truncate the PWM drive signal and continue to truncate the PWM drive signal until the comparing circuit 316 indicates that the over-current condition no longer exists. For example, the inverted over-current signal may be provided to the AND logic gate, which also receives the PWM controller 310 signal. Consequently, the PWM controller 310 signal is only provided to the output stage 106 when the over-current signal is low, i.e., when an over-current condition is not detected. If an over-current condition is detected, the output of the AND logic gate 416 is driven low until the over-current signal returns to a low state.

Alternatively, the OCP circuit 312 may operate in the latched mode in which the OCP Circuit 312 truncates or otherwise disables the PWM drive signal upon detection of an over-current condition and re-enables the PWM drive signal only in response to another event other than termination of the over-current condition, such as until the end of the current PWM cycle. For example, in the latched mode, the present latch circuit 418 disables the PWM drive signal by setting its output, thus asserting a high signal that is provided to the AND gate 416 and driving the output of the AND gate to zero. The output of the latch circuit 418 remains high until the reset input is pulsed, indicating the beginning of another PWM cycle. Consequently, the OCP circuit 312 selectively truncates the drive signal for the remaining duration of the PWM drive signal pulse in which the over-current condition occurs, thus selectively and independently truncating each individual pulse of the PWM drive signal.

Further, the OCP circuit 312 may selectively truncate the PWM drive signal according to a selected blanking period (620). For example, the OCP circuit 312 may detect the rising edge of the PWM controller 310 signal and disable the PWM drive signal following the selected blanking period. In the present embodiment, the blanking circuit 510 maintains a high signal at the R input of the latch circuit 418 upon detecting the rising edge of the PWM controller 310 signal. The blanking circuit 510 maintains the high signal level until the selected blanking period ends. The entire process may then repeat to continue modulating the voltage and current supplied to the load 102.

The particular implementations shown and described are illustrative of the invention and its best mode and are not intended to otherwise limit the scope of the present invention in any way. For the sake of brevity, conventional manufacturing, connection, preparation, and other functional aspects of the system may not be described in detail. The connecting lines shown in tile various figures are intended to represent exemplary functional relationships and/or physical couplings between the various elements. Many alternative or additional functional relationships or physical connections may be present in a practical system.

In the foregoing description, the invention has been described with reference to specific exemplary embodiments; however, it will be appreciated that various modifications and changes may be made without departing from the scope of the present invention as set forth herein. The description and figures are to be regarded in an illustrative manner, rather than a restrictive one and all such modifications are intended to be included within the scope of the present invention. Accordingly, the scope of the invention should be determined by the generic embodiments described herein and their legal equivalents rather than by merely the specific examples described above. For example, the steps recited in any method or process embodiment may be executed in any order and are not limited to the explicit order presented in the specific examples. Additionally, the components and/or elements recited in any apparatus embodiment may be assembled or otherwise operationally configured in a variety of permutations to produce substantially the same result as the present invention and are not limited to the specific configuration recited in the specific examples.

Benefits, other advantages and solutions to problems have been described above with regard to particular embodiments, however, any benefit, advantage, solution to problems or any element that may cause any particular benefit, advantage or solution to occur or to become more pronounced are not to be construed as critical, required or essential features or components.

As used herein, the terms “comprises”, “comprising”, or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components. used in the practice of the present invention, in addition to those not specifically recited, may be varied or otherwise particularly adapted to specific environments, manufacturing specifications, design parameters or other operating requirements without departing from the general principles of the same.

1. A power supply for supplying a load, comprising:
an output stage; and
a control system driving the output stage, comprising:
a PWM controller adapted to provide a drive signal to the output stage; and
an over-current protection circuit adapted to:
sense an over-current condition at the load; and
truncate the drive signal in response to the over-current condition.

2. A power supply according to claim 1, wherein the control system comprises a comparator adapted to:
compare a reference signal to a load current signal; and
generate an over-current signal according to the comparison.

3. A power supply according to claim 1, wherein the over-current protection circuit is adapted to detect a rising edge of each cycle of the drive signal and truncate the drive signal after detection of the rising edge.

4. A power supply according to claim 3, wherein the over-current protection circuit is adapted to truncate the drive signal after detection of the rising edge and a selected blanking period.

5. A power supply according to claim 4, wherein the blanking period comprises an adjustable blanking period.

6. A power supply according to claim I, wherein the over-current protection circuit is adapted to truncate the drive signal only for the duration of the over-current condition.

7. A power supply according to claim 1, wherein the over-current protection circuit is adapted to truncate the drive signal for the remaining duration of a drive signal pulse in which the over-current condition occurs.

8. A power supply according to claim 1, wherein the over-current protection circuit is adapted to selectively and independently truncate each individual pulse of the drive signal.

9. A power supply for supplying a current to a load, comprising:
a PWM controller adapted to generate a PWM drive signal;
an output stage responsive to the PWM controller and adapted to supply the current to the load according to the drive signal;
a sensor adapted to determine the magnitude of the load current; and
an over-current protection circuit responsive to the sensor and adapted to selectively truncate the PWM drive signal in response to an over-current condition in the magnitude of the current.

10. A power supply according to claim 9, wherein the over-current protection circuit comprises a comparator adapted to:
compare a reference signal to the magnitude of the load current; and
generate an over-current signal according to the comparison.

11. A power supply according to claim 9, wherein the over-current protection circuit is adapted to detect a rising edge of each cycle of the PWM drive signal and truncate the PWM drive signal after detection of the rising edge.

12. A power supply according to claim 11, wherein the over-current protection circuit is adapted to truncate the drive signal after detection of the rising edge and a selected blanking period.

13. A power supply according to claim 12, wherein the blanking period comprises an adjustable blanking period.

14. A power supply according to claim 9, wherein the over-current protection circuit is adapted to truncate the drive signal only for the duration of the over-current condition.

15. A power supply according to claim 9, wherein the over-current protection circuit is adapted to truncate the drive signal for the remaining duration of a drive signal pulse in which the over-current condition occurs.

16. A power supply according to claim 9, wherein the over-current protection circuit is adapted to selectively and independently truncate each individual pulse of the drive signal.

17. A method of supplying a current to a load, comprising:
supplying the current to the load according to a PWM drive signal;
sensing an over-current condition in the current at the load; and
selectively truncating the PWM drive signal according to the over-current condition.

18. A method of supplying a current to a load according to claim 17, wherein the sensing the over-current condition comprises:
comparing a reference signal to a load current signal; and
generating an over-current signal according to the comparison.

19. A method of supplying a current to a load according to claim 17, wherein selectively truncating the PWM drive signal comprises:
detecting a rising edge of each cycle of the PWM drive signal; and
truncating the drive signal after detecting the rising edge.

20. A method of supplying a current to a load according to claim 19, wherein selectively truncating the PWM drive signal comprises selectively truncating the drive signal after detecting the rising edge and a selected blanking period.

21. A method of supplying a current to a load according to claim 20, wherein the blanking period comprises an adjustable blanking period.

22. A method of supplying a current to a load according to claim 17, wherein selectively truncating the PWM drive signal comprises selectively truncating the drive signal only for the duration of the over-current condition.

23. A method of supplying a current to a load according to claim 17, wherein selectively truncating the PWM drive signal comprises selectively truncating the drive signal for the remaining duration of a drive signal pulse in which the over-current condition occurs.

24. A method of supplying a current to a load according to claim 17, wherein selectively truncating the PWM drive signal comprises selectively and independently truncating each individual pulse of the drive signal.
